(19) United States
(12) Patent Application Publication
(10) Pub. No.: US 2025/0194473 A1
(43) Pub. Date: Jun. 19, 2025

(54) Actuator for Handling Plants and/or Plant Receptacles in a Vertical Farming Facility

(71) Applicant: Suiteg GmbH, Köln (DE)

(72) Inventors: Martin Vesper, Wuppertal (DE); Volker Deckers, Gangelt (DE); Yuriy Fedyuk, Kiev (UA); Yurii Stovbun, Kiev (UA); Vasyl Rybak, Kiev (UA)

(21) Appl. No.: 18/847,307

(22) PCT Filed: Mar. 17, 2023
(86) PCT No.: PCT/EP2023/056867

§ 371 Date: Sep. 16, 2024

(30) Foreign Application Priority Data
Mar. 17, 2022 (EP) 22162785.4

(51) Int. Cl. A01G 9/14; A01G 9/02; A01G 9/26; B25J 11/00

(52) U.S. Cl. CPC A01G 9/143; A01G 9/022; A01G 9/26; B25J 11/0045

(57) ABSTRACT

An actuator for handling plants and/or plant receptacles in a vertical farming facility, the actuator includes a robot head for inserting the plants and/or the plant receptacles into apertures of a planting wall of the vertical farming facility, the actuator further includes an application that is configured to open the apertures prior to inserting the plants and/or plant receptacles by the robot head.

### CROSS REFERENCE TO RELATED APPLICATIONS

This application is a US National Stage Entry of PCT/EP2023/056867 filed on Mar. 17, 2023, which claims priority to EP 22162785.4 filed on Mar. 17, 2022, all of which are hereby incorporated by reference herein for all purposes.

### FIELD

The present invention relates to a system for transporting a robot head in a vertical farming facility, wherein plants can be cultivated.

### BACKGROUND

Traditionally, plants are grown by farmers by way of field cultivation. For this purpose, specific atmospheric conditions are indispensable for successful cultivation. In particular, the soil must be rich in humus and hence provide sufficient amounts of nutrients. Furthermore, the soil as well as the ambient air must provide enough humidity so as to promote plant growth. Moreover, adequate radiation must be ensured. In addition and importantly, plant cultivation is inextricably linked to a provision of sufficient acreage.

The global population and therefore the demand for sufficient food is increasing incessantly. the same time—among others due to anthropogenic industrial emissions and other human interferences in the natural planetary systems over the course of globalization—the climate is subject to long-term changes, especially to unfavorable changes from the standpoint of plant cultivation: Heat waves and water scarcity, but also a lack of soil nutrients as a consequence of monocultural farming et cetera are some of the challenging phenomena and examples for the deterioration of cultivation conditions that farmers are currently faced with and most likely will be confronted with on a regular basis in the future. According to scientific disclosures the adverse agricultural conditions will subsist and the challenging phenomena will occur even more frequently, when steady, predictable and controllable cultivation conditions are actually required for optimal agricultural outputs.

One approach in solving this problem can be found in the so-called inhouse or vertical farming technologies of growing crops in vertically stacked layers arranged inside buildings, containers or the like. This technology incorporates controlled-environment agriculture in order to optimize plant growth and to increase crop yield and goes along with a smaller cropland. Furthermore, vertical farming enables a decrease of human interference in the cultivation process due to automatization which increases the overall performance since machines don't need sleep or vacation and are not affected by sentiment fluctuations and thus are much less prone to errors. Automatization is expected to increase over time along with developments in machine learning and artificial intelligence. Also, vertical farming goes hand in hand with the benefit of reducing transportation efforts since the cultivation can be carried out in urban territories, close to consumers, thereby rendering pollutive and costly shipments superfluous.

However, a current drawback of this approach is that vertical farming is associated with a tremendous energy consumption compared to classical field cultivation due to the fact that lighting, climate control and nutrients must be provided entirely by technical means. Consequently, vertical farming can only be a solution to the afore-mentioned challenges when energy consumption and costs are reduced and degree of automation as well as crop yield are increased significantly.

### SUMMARY

It is an object of the present invention to provide an actuator that addresses at least some of the above-mentioned challenges and drawbacks.

The object of the present invention is achieved by an actuator for handling plants and/or plant receptacles in a vertical farming facility, wherein the actuator comprises a robot head for inserting plants and/or plant receptacles into apertures of a planting wall of the vertical farming facility, wherein the actuator further comprises an applicator, wherein the applicator is configured to open the apertures prior to inserting the plants and/or plant receptacles.

According to the present invention, it is advantageously possible to handle plants and/or plant receptacles within a vertical farming facility. Plants and/or plant receptacles can be transferred to and implanted into dedicated apertures in planting walls. Preferably, the apertures do not have a fixed profile but are formed flexible in terms of changeable cross sections. A modifiable cross section can facilitate the planting process of the plants and/or plant receptacles and provide in addition mechanical stability for the plants and/or plant receptacles. Such apertures with variable cross sections can be provided, for instance, by a two-part foam material that is arranged in, on or around the apertures or a combination thereof. The inventive applicator can enlarge the cross sections, wherein subsequently plants and/or plant receptacles can be put or inserted into by means of the robot head. The robot head comprises preferably a gripper. Without an inventive applicator the two functionalities—firstly the widening of the aperture and secondly the inserting of the plants and/or plant receptacles—would be done by a single means, for instance by the gripper holding a plant receptacle. That on the other hand can impose higher requirements, for instance to the design of the plant receptacle. It is conceivable, for instance, that the plant receptacle is at least partially tapered along its length so as to simplify the process of implanting/inserting. The allocation of the two separate functionalities to two different means—the applicator and the gripper—can constitute an optimization of the planting process from the standpoint of energy efficiency, in accordance with the phenomenon of specialization in a variety of other processes. Furthermore, it is advantageously possible to insert the plants and/or plant receptacles in different angles or inclinations with respect to the planting walls. Different inclinations can be conceivable for a beneficial radiation of the plants and/or plant receptacles. Furthermore, it is easy to conceive an embodiment of the invention that is designed to insert solely plants rather than plants and/or plant receptacles.

In a preferred embodiment of the present invention, the applicator is rotatably connected to the actuator, wherein the applicator is rotatable about a pivot axis. The applicator is rotatable around the pivot axis in order to open the apertures at least partially. Rotation of the applicator can be carried out simply by an electric motor. Also, it is sufficient for the inventive applicator to be rotated about a single axis but it is also conceivable that the applicator is configured such that it can be rotated around more than one axis. Furthermore, it can be sufficient to rotate the applicator in one single direction around an axis. But an embodiment that allows the applicator to be rotated bilaterally around the pivot axis is also conceivable. In other words, the applicator can be configured such that it can be rotated in two opposite peripheral directions about the said pivot axis. Moreover, widening the apertures can be accomplished by rotating the applicator by a finite angular range, for instance by 150° or 180° or 210° or the like. But it is also conceivable to configure the applicator such that it can be rotated entirely, meaning by 360°.

Preferably, the applicator comprises a connecting means and a wedge-shaped opening means, the opening means extending at least partially along an outer circumference of the applicator and being formed concentrically or eccentrically around a pivot axis. Design or more specifically external contours of the applicator can determine the extent of the widening of the apertures. Particularly, a width of the applicator parallel to the pivot axis can be determining for the size of the opened aperture. Preferably, the cross section of the opened aperture is greater than a cross section of the plant and/or plant receptacle. But it is also conceivable that the plant and/or plant receptacle widens the aperture as well, at least partially, while the plant and/or plant receptacle is being inserted into the aperture. The widening of the aperture can be preferably carried out by the opening means of the applicator. For that purpose, a wedge or conical shape of the opening means is particularly advantageous. The wedge-shaped opening means enables a gradual enlarging of the aperture, wherein a rotation angle of the applicator can correlate with the cross section of the opened aperture. Furthermore, the opening means can be formed concentrically or eccentrically. Concentricity indicates a constant distance between the pivot axis and the outer circumference of the opening means, whereas eccentricity refers to, for instance, a gradually increasing distance between the pivot axis and the outer circumference of the opening means. An eccentric configuration of the opening means can particularly widen the aperture in a direction perpendicular to a width of the aperture. In other words, while the width of the applicator can determine the width of the aperture, the eccentricity of the applicator can determine a depth or length of the aperture. In addition, the applicator can be connected to the actuator via the connecting means, wherein the pivot axis can be arranged at the connecting means. Moreover, the opening means can be made by a single metal, a metal alloy, a plastic or the like.

According to the present invention, the opening means comprises a first wing and a second wing, the two wings being at least partially connected to each other. An applicator comprising two wings can easily form a tapered design that is advantageous for opening apertures in the planting walls. It is conceivable that the two wings are arranged entirely divergent with respect to each other, but they can also be, at least partially, parallel to each other. The two wings can be identical in shape and size but they can also, at least partially, differ from one another. They can comprise pointed or rounded edges or a combination thereof.

In a preferred embodiment of the present invention, the two wings are formed as a single piece. The two wings can be made by a sheet metal, wherein the desired external contours of the wings can be produced by punching. Once the final shape of the wings is in place, the sheet can be bent or folded—for instance along an axis of symmetry—such that a tapered design for the opening means can be generated. A resulting folding edge can be used, at least partly, as a foremost line making its way through and widening the aperture, similar to the foremost line of an axe wedge advancing through wood.

According to the present invention, the applicator comprises a spacer, the spacer having a first end and a second end, the first end being connected to the first wing and the second end being connected to the second wing. A spacer between the two wings can ensure dimensional stability of the opening means by mechanically supporting them in a direction parallel to the pivot axis. Preferably, the spacer is arranged parallel to the pivot axis. But it is also conceivable to arrange the spacer skew with respect to the pivot axis. Moreover, the spacer preferably is elongated with a main extension direction, similar to a metal pin. It can have a circular or rectangular or another cross section. Furthermore, it can be, at least partially, threaded, for instance at the first end and second end in order to connect the spacer to the wings on both its sides using nuts. In addition, it is conceivable to employ a spacer configuration that allows a modifiable distance between the two wings. In other words, the length of the spacer can be mutable, for instance by adjusting the distance between the two wings by means of the nuts and threads at the first and second end. Also, a helical spring can be used as a spacer. It is further conceivable for the spacers to be made of a variety of materials such as metals or plastics.

Preferably, the opening means extends from a tip portion to an end portion, wherein the tip portion is, with respect to the direction of the pivot axis, narrower than the end portion. Preferably the width of the tip portion in a direction parallel to the pivot axis is narrower than the same width at the end portion in order to realize or at least approximate a wedge shape of the opening means. The extension between the tip portion and the end portion can be solid but it can also be hollow. However, the exact design in-between the tip portion and the end portion can be formed in a variety of ways. In other words, there is a manifold of ways to form the opening means itself. For instance, starting at the tip portion, the said width can increase in a direction from the tip portion to the end portion, only to decrease again at the end portion, at least a bit. In other words, external design of the opening means can be, at least partly, concave or bulbous. Also, the opening means can comprise movable elements that are movably connected to the opening means, for instance in order to change the said width, at least temporarily. Preferably, the tip portion comprises, at least partly, the aforementioned folding edge that serves among others as a connection between the two wings. Preferably, the aforementioned spacer is arranged in the second half with respect to a length in the direction from the tip portion to the end portion.

In a preferred embodiment of the present invention, the opening means comprises an external width parallel to the pivot axis, the external width increasing continuously from the tip portion till the end portion. It is conceivable to have a convex external design of the opening means. In other words, the external width parallel to the pivot axis can increase continuously in the direction from the tip portion to the end portion, similar to the letter V, wherein the distance between the two diverging and inclined lines increases exponentially rather than linearly. Such a design advantageously enables the gradual widening of apertures while the applicator is rotated.

According to the present invention, the opening means comprises a groove at its outer circumference which is tapered in a peripheral direction in such a manner that an internal width of the groove parallel to the pivot axis increases in a pivoting direction around the pivot axis from the tip portion till the end portion. Preferably, as the applicator rotates and the aperture in the planting wall and/or foam material further widens, the groove forms a cavity in the planting wall and/or foam material, the cavity's volume ever-growing as the rotation progresses due to the tapered shape of the groove in the peripheral direction. Due to its conical or tapered shape, the groove can comprise an angle that determines the size of the cavity formed by the groove. Preferably, the angle is greater than 15°. Particularly preferred is a groove angle that is greater than 30°.

Preferably, the actuator is configured in such a manner that the tip portion is at least partially inserted into an aperture of the planting wall in a first step and that the applicator is rotated about the pivot axis in pivoting direction to enlarge an opening cross-section of the aperture in a second step. Preferably, the width parallel to the pivot axis at the tip portion is very small, for instance less than 6 mm or, particularly preferred, less than 3 mm. A smallest possible width reduces the insertion resistance of the applicator into the planting wall and/or foam material in the first step. A smallest possible width of the tip portion also simplifies further penetration of the planting wall and/or foam material by the applicator as the rotation progresses and therefore facilitates cavity creation during the second step. Advantageously, the opened cross section of the aperture and along with it the size of the cavity volume increases proportionally to the rotation angle, at least up to a certain rotation angle. Exceeding the said certain rotation angle can result in a diminution of the cavity volume and, at worst, in the applicator exiting the planting wall and/or foam material, resealing the previously created cavity volume. It is therefore preferred to align the external design of the opening means, the groove angle, the required rotation angles in operation et cetera.

According to the present invention, the actuator is configured in such a manner that the plant and/or plant receptacle is inserted into the opened aperture by the gripper in a third step.

Preferably, just before the third step is completed, the opened aperture is sufficiently large to accommodate a plant and/or a plant receptacle therein. The gripper then can insert the plant and/or plant receptacle into the aperture before completing the third step. Therefore, the gripper advantageously is arranged close to the applicator. Firstly, it is conceivable that the gripper is movably connected to the applicator, thus being constantly located in the proximity of the applicator and, hence, anytime ready to insert a plant and/or plant receptacle in a recently created cavity. But it is easy to conceive an embodiment, wherein the gripper is separate from the applicator. Preferably, while carrying out the third step, the gripper is arranged in a position that is closer to the end portion than the tip portion.

Another subject of the present invention is a vertical farming facility comprising a planting wall and an actuator according to one of the aforementioned embodiments. A vertical farming facility according to the present invention can be a container or a greenhouse. But other embodiments are conceivable as well. Aforementioned advantages also apply to the vertical farming facility that comprises the actuator. Overall, the vertical farming facility increases degree of automation of the process of plant cultivation. It therefore enhances the efficiency of the cultivation process which enables cost reduction and crop yield augmentation.

Preferably, the vertical farming facility comprises a cantilever and a beam, the beam being movably connected to the cantilever and the actuator being movably connected to the beam, the cantilever is arranged mainly horizontally and comprises a cantilever axis and the beam is arranged mainly vertically and comprises a beam axis, and the cantilever is movable within the vertical farming facility. The cantilever can be seen as a specific type of beam. The cantilever and the beam feature different spatial alignments in order to increase range of motion of the actuator. Either one can be characterized by a main body that can be made of a single metal, steel or another alloy for an increase in strength and/or hardness. They can have a variety of cross sections and be formed, for instance, as double-T beams. But other materials as well as other cross sections are also conceivable, for instance to save money or increase quality and/or longevity of the employed parts. Both the cantilever and the beam have a main extension direction with a cantilever axis and a beam axis, wherein their cross sections, if needed, are non-constant along their main extension direction. In other words, the cantilever and the beam can each comprise multiple sections, the multiple sections having different profiles or cross sections. The feature of non-parallelism of the cantilever and the beam, both having a different orientation in space, can facilitate operation by enabling transportation of plants and/or plant receptacles to a myriad of positions within the vertical farming facility. An eventual relative motion between the cantilever and the beam can increase the utility of the arrangement by enhancing its agility or so to say flexibility. Furthermore, the movability of the beam relative to the cantilever can increase the energy efficiency since situationally, it can be sufficient to move solely the beam rather than the cantilever and the beam. Moreover, the actuator that is movably attached to the beam can comprise multiple arms that are rotatably connected to each other which in turn raises the flexibility of the vertical farming facility by increasing the number of degrees of freedom of the actuator. Also, multiple arms enable the gripper to seize plants and/or plant receptacles round corners.

In a preferred embodiment of the present invention, the cantilever comprises a first free end section and a first connecting end section and/or the beam comprises a second free end section and a second connecting end section, wherein the cantilever is arranged beneath and perpendicular to the planting walls, the planting walls being parallel to each other, connected via the first free end section to a second facility wall and via the first connecting end section to a first facility wall, the first facility wall and the second facility wall being parallel to each other, movable translationally in a direction parallel to the facility walls. The cantilever and the beam can be formed advantageously in an elongated manner, each one comprising two end sections. The end sections can be defined, for instance, as the last 10% or 20% or 30% in terms of length with respect to the entire length of the cantilever and the beam. The end sections, particularly the connecting end sections, can be used advantageously for connecting other bodies or devices onto them that might be necessary for operation of the system, such as pedestal bearings that enable motion of the actuator along a desired motion path. The end sections can comprise exterior surfaces, internal volumes and especially end faces, the end faces being preferably arranged perpendicular to adjacent surfaces. Furthermore, the cantilever is arranged movably underneath the planting walls. In other words, a vertical distance between a facility ground and a lowest edge of the planting walls is greater than a maximum vertical dimension of the cantilever so that a collision between the cantilever and the planting walls is prevented at all times. Advantageously, the both end sections of the cantilever are connected to the facility walls by means of wall rails. That way, the cantilever can be supported bilaterally and bending of the cantilever can be restricted. A wheel at each end of the cantilever can be rotatably connected to the cantilever. It is conceivable that both wall rails have a cross section similar to a U-like shape. In other words, the wall rails can be formed rectangularly, wherein a top side of the rectangle is open and directed upwardly, two opposing sides extend vertically and serve as side panels for the wheels and a fourth/bottom side upon which the wheels can rest supports the wheels and thus carries the weight of the cantilever at least partially. Due to the open top side of the wall rails the wheels that are attached to the cantilever can be placed into the wall rails top-down.

Another subject of the present invention is a method for inserting plants and/or plant receptacles into a planting wall in a vertical farming facility with an applicator according to one of the abovementioned embodiments, wherein the applicator is at least partially inserted into an aperture of the planting wall in a first step, the applicator is rotated about a pivot axis in a pivoting direction to enlarge an opening cross-section of the aperture in a second step and the plant and/or plant receptacle is inserted into the opened aperture by a gripper in a third step. Advantages, technical effects and further attributes of the aforementioned embodiments of the actuator and of the vertical farming facility also apply to the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

### BRIEF DESCRIPTION OF THE DRAWINGS

FIG. 1 illustrates schematically a first embodiment of an applicator according to the present invention in a perspective view.

FIG. 2 illustrates schematically a second embodiment of the applicator according to the present invention in a perspective view.

FIG. 3 illustrates schematically a first step of a method according to the present invention.

FIG. 4 illustrates schematically a second step of the method according to the present invention.

FIG. 5 illustrates an embodiment of a vertical farming facility according to the present invention in a perspective view.

FIG. 6 illustrates an actuator according to the present invention inserting plants and/or plant receptacles in a planting wall.

FIG. 7 illustrates a first embodiment of a gripper according to the present invention in a release position.

FIG. 8 illustrates schematically a second embodiment of the gripper head along with a plant receptacle and a plant therein in a release position in a side view.

FIG. 9 illustrates schematically the gripper head of FIG. 8 along with a plant receptacle and a plant therein in a clamping position in a perspective view.

### DETAILED DESCRIPTION

The present invention will be described with respect to particular embodiments and with reference to certain drawings but the invention is not limited thereto but only by the claims. The drawings described are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

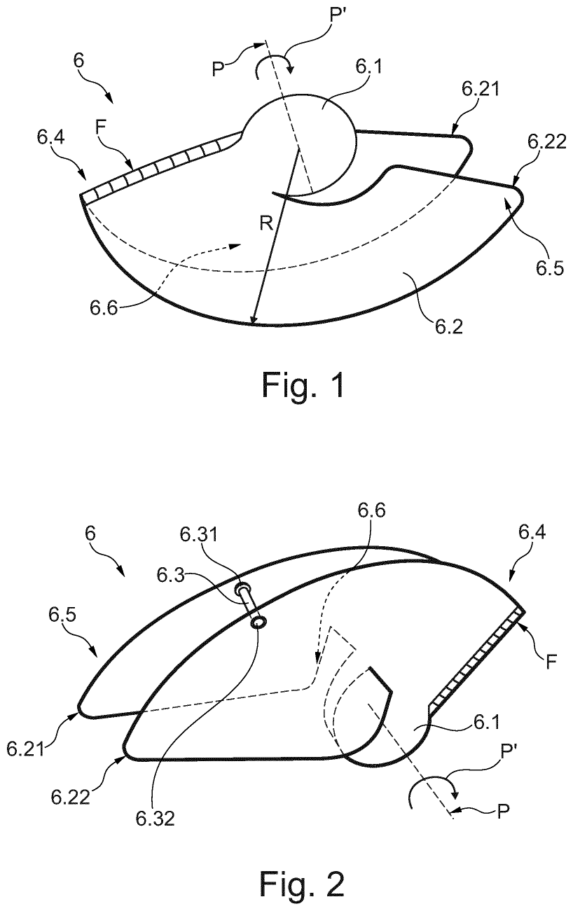

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described and/or illustrated herein. In FIG. 1, a first embodiment of an applicator 6 according to the present invention is illustrated schematically in a perspective view. The applicator 6 comprises a connecting means 6.1 that is illustrated in an abstract manner. The connecting means 6.1 is formed, at least partially, such that its external contours are circular. The applicator 6 can be connected to an actuator 1 via the connecting means 6.1, for instance by means of bolting.

The applicator 6 further comprises a pivot axis P that is arranged perpendicular to the connecting means 6.1. The applicator 6 can be rotated around the pivot axis P, preferably in a peripheral direction P′, endlessly. In other words, the applicator 6 can be repeatedly rotated by 360° and is not restricted to an angle range. Furthermore, the connecting means 6.1 is arranged within a plane that divides the applicator 6 into two symmetrical halves, the plane being perpendicular to the pivot axis P and not shown in the FIG. 1.

In addition, the applicator 6 comprises an opening means 6.2. The opening means 6.2 constitutes the main body of the applicator 6 and comprises a first wing 6.21 and a second wing 6.22. The opening means 6.2 further comprises a tip portion 6.4 and an end portion 6.5 and extends from the tip portion 6.4 to the end portion 6.5. The two wings 6.21, 6.22 are arranged on either side of the aforesaid plane and arranged such that they diverge in a direction from the tip portion 6.4 to the end portion 6.5, widening the opening means 6.2. In other words, an external width of the opening means 6.2, the width being measured parallel to the pivot axis P, is increasing in the direction from the tip portion 6.4 to the end portion 6.5. That way, an advantageous wedge shape of the applicator 6 is materialized.

The applicator 6 is manufactured by an even sheet metal, wherein the source material is punched, the punching determining the outer shape and design of the applicator. Subsequent to the punching, the sheet metal is folded or bent along a symmetry axis, thereby creating a folding edge F. The folding edge F forms a transition line between the first wing 6.21 and the second wing 6.22. It particularly acts as the foremost section of the applicator 6 while the applicator 6 is being rotated, thereby penetrating an aperture 7 in a planting walls 20′ and/or foam material 20″″. To put it in other words, the folding edge F cuts through the aperture, wherein cutting is to be understood in a figurative sense and not literally. The folding edge F comprises a smallest possible folding radius in order to, so to speak, sharpen the folding edge.

The applicator 6 can be visualized, roughly speaking and in simplistic terms, like a traditional circular Mexican taco that is folded symmetrically along a diameter such that one half is overlapping the other. The both halves of the taco can be considered to be the two wings 6.21, 6.22.

A groove 6.6 is formed in-between the two wings 6.21, 6.22, the groove 6.6 being tapered in the direction from the tip portion 6.4 to the end portion 6.5. In other words, there is an internal width between the two wings, the internal width being arranged parallel to the pivot axis P and increasing along the direction from the tip portion 6.4 to the end portion 6.5.

A radius R of the applicator 6 that is directed from the pivot axis P to a respective outer circumference of each wing 6.21, 6.22 is constant. In other words, the first embodiment of the applicator 6, as shown in the FIG. 1, is formed concentrically. However, another conceivable embodiment can comprise a radius R that increases in the direction from the tip portion 6.4 to the end portion 6.5, rendering the applicator 6 eccentric.

In FIG. 2, a second embodiment of the applicator 6 according to the present invention is illustrated schematically in a perspective view. Both embodiments, in the FIGS. 1 and 2, are identical in terms of their effect while the applicators 6 are in operation. One substantial difference between the two embodiments is that the second embodiment comprises a spacer 6.3 that is arranged close to the outer circumference of the two wings 6.21, 6.22 and along a second half of a length of the opening means 6.2. The spacer 6.3 further is arranged parallel to the pivot axis P. Moreover, it is formed as a metal pin comprising a first end 6.31 and a second end 6.32, the spacer 6.3 being threaded along its entire length. The first end 6.31 is connected to the first wing 6.21 and the second end 6.32 is connected to the second wing 6.22 by means of four nuts in total, two nuts on each side of either wing 6.21, 6.22 clamping the wings 6.21, 6.22 locally in the direction of the main extension of the spacer 6.3. The internal width of the applicator 6 can be adjusted with the spacer 6.3 by changing the positions of the four nuts along the threaded spacer 6.3. Overall, the distance between the wings 6.21, 6.22 can be modified depending on the required size of the aperture 7. The required size of the aperture 7 on the other hand depends on the dimensions of the plant 2′ and/or plant receptacle 2 to be inserted into the panting walls 20′.

The spacer 6.3 increases the stiffness of the applicator 6. An alternative way to augment the stiffness of the applicator 6 is to use a sheet metal with a higher thickness.

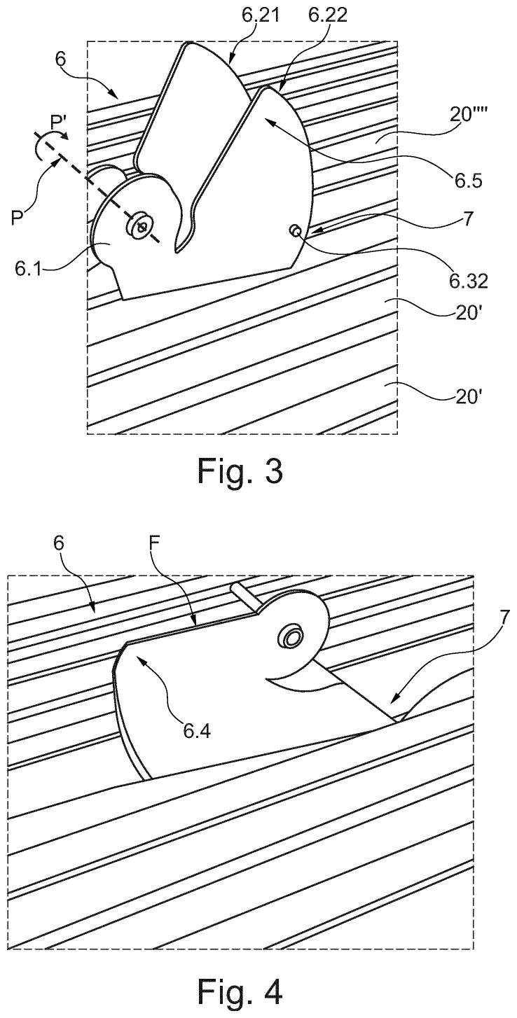

In FIG. 3, a first step of a method according to the present invention is illustrated. The tip portion 6.4 of the applicator 6 is at least partially inserted into the aperture 7 of the planting wall 20′ by rotating the applicator 6 around the pivot axis P in the direction P′. More precisely, the applicator 6 is inserted into foam materials 20″″ that are arranged on the planting wall 20′. By further rotating the applicator 6 in the direction P′, as shown in FIG. 4, a cross section of the aperture 7 is being enlarged due to the tapered shape of the applicator 6 in the direction of rotation. Thus, a cavity is created in the planting wall 20′ wherein in a third step a gripper 1′ can insert a plant 2 and/or plant receptacle 2. A further rotation of the applicator 6 would abruptly close the previously opened aperture 7 once the end portion 6.5 exits the foam material 20″″.

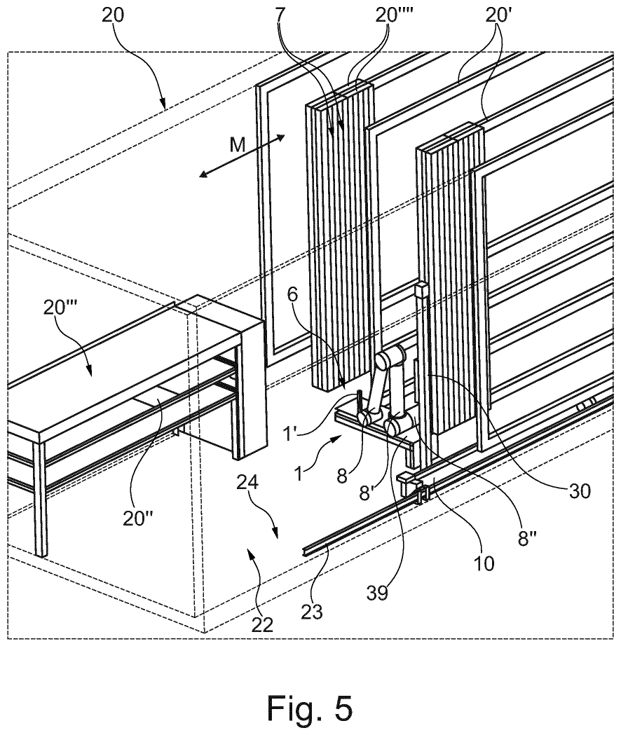

In FIG. 5, a vertical farming facility 20 is illustrated schematically in a perspective view. The depicted vertical farming facility 20 is a container.

The vertical farming facility 20 comprises a cantilever 10 that is arranged horizontally, parallel to a facility ground 24. The vertical farming facility 20 further comprises a beam 30 that is arranged vertically, perpendicular to the facility ground 24 and the cantilever 10. Furthermore, it comprises an actuator 1 for handling plants 2′ and/or plant receptacles 2. The actuator 1 has six different components: an applicator 6, a gripper 1′ as a robot head for clamping and handling plants 2′ and/or plant receptacles 2, an articulated arm 8 that is rotatably connected to the gripper 1′, a further articulated arm 8′ that is rotatably connected to the articulated arm 8, a base member 8″ that supports the further articulated arm 8′ and finally a shelf 39. The most distal components of the actuator 1 are the applicator 6 and the gripper 1′. The most proximal component of the actuator 1 is the base member 8″.

The vertical farming facility 20, as shown in the FIG. 5, is taken out of operation. In other words, the vertical farming facility 20 is shut down and the actuator is in a parking position. More specifically, the actuator 6 along with the cantilever 10 and the beam 30 are arranged within the vertical farming facility 20 such that they are positioned close to a first facility wall 22, for instance for potential activities like repair, maintenance or overhaul. In the parking position, the cantilever 10 is arranged parallel to the first facility wall 22, thereby taking up little space, in particular not protruding into a facility volume and obstructing the room inside the vertical farming facility 20.

The cantilever 10 is connected to the first facility wall 22 of the vertical farming facility 20. More explicitly, the cantilever 10 is connected indirectly to the first facility wall 22 by means of a first wall rail 23, the first wall rail 23 being fixed to the first facility wall 22 using bolting. The first wall rail 23 is formed straightly and also arranged parallel to the facility ground 24.

The FIG. 5 also depicts a nursery station 20′″ that is located at an entrance of the vertical farming facility 20. The nursery station 20′″ resembles a workbench and comprises surfaces to set trays 20″ thereon. For illustrative purposes, a single tray 20″ is put on one of the surfaces of the nursery station 20′″. The trays 20″ can comprise a multitude of plants 2′ and/or plant receptacles 2. Furthermore, the nursery station 20640 ″ acts as a temporary storage means for the trays 20″ prior to picking the trays 20″ with plants 2′ and/or plant receptacles 2 therein, setting them on the shelf 39, transporting them to planting walls 20′ and finally inserting them into the planting walls 20′.

The planting walls 20′ are arranged parallel to each other and extend along a main length direction M of the vertical facility 20. They are equally shaped and sized and connected to the vertical farming facility 20 such that they hover. In other words, there is a vertical distance between the facility ground 24 and a lower edge of each planting wall 20′. Moreover, the planting walls 20′ are configured movably. The planting walls 20′ are particularly movable translationally towards each other, while keeping parallelism. In other words, the planting walls 20′ can be moved individually perpendicular to the first wall rail 23. But it is also conceivable to configure the planting walls 20′ such that they are movable parallel to the first wall rail 23, the distance between the planting walls 20′ remaining unchanged. Furthermore, other embodiments, wherein a combination of parallel and perpendicular motion of the planting wall 20′ with respect to the first facility wall 22 or the first wall rail 23 is conceivable. Moreover, the planting walls 20′ are covered on both sides with a foam material 20″″ that enables simple and firm inserting of the plants 2′ and/or plant receptacles 2 into the planting walls 20′. Apertures 7 that are formed in the foam material 20″″ are configured to accommodate the plants 2′ and/or plant receptacles 2, wherein the apertures 7 are positioned in an overlapping manner with respect to openings in the planting walls 20′, thereby ensuring that the plants 2′ and/or plant receptacles 2 are plugged in to the foam material 20″″ and the planting wall 20′ at the same time. The apertures 7 are arranged perpendicular to the facility ground 24 but they can be arranged parallel to the facility ground 24 as well. Also, a combination of perpendicular and parallel apertures 7 is possible. The apertures 7 can be widened by the applicator 6 and the gripper 1 can insert the plants 2′ and/or plant receptacles 2 into the planting walls 20′.

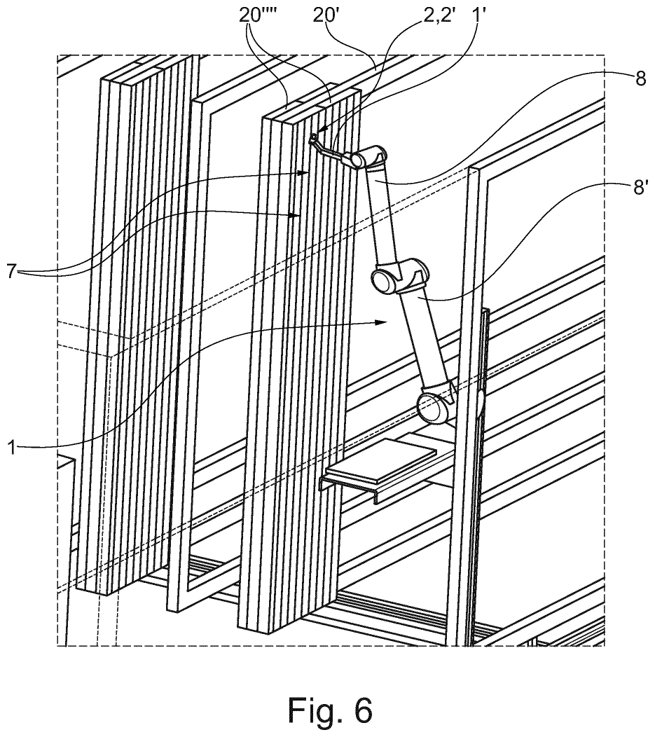

In FIG. 6, the vertical farming facility 20 is shown while the actuator 1 is inserting a plant receptacle 2 with a plant 2′ therein into a planting wall 20′. For this purpose, the applicator 6—that is not specifically shown in the FIG. 6 for the purpose of clarity—has widened an aperture 7 where the gripper 1′ is inserting a plant receptacle 2 into. Advantageously, the plant receptacle 2 is inserted such that the plants 2′ and/or plant receptacles 2 have an angle with respect to the planting wall 20′ and/or foam material 20″″. Preferably, despite an eventual inclination, the plants 2′ are at least partly directed to a ceiling of the vertical farming facility 20, where appropriate lighting devices are arranged for sufficient radiation of the plants 2′ and therefore for successful cultivation.

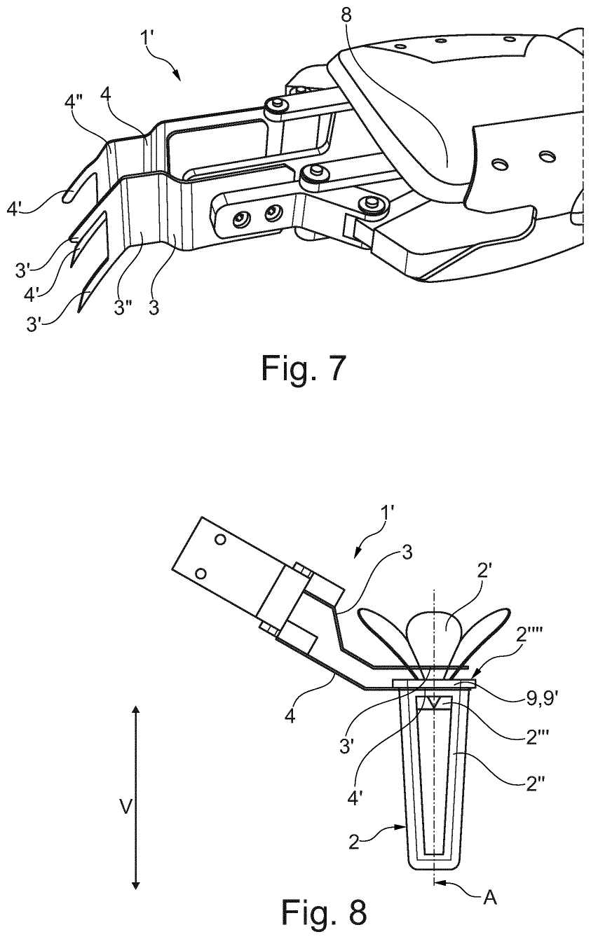

In FIG. 7, a first embodiment of the gripper 1′ for handling plants 2′ or plant receptacles 2 in a vertical farming facility 20 is illustrated. The gripper 1′ forms one of the most distal parts of the actuator 1 and allows for a connection to plants 2′ or plant receptacles 2 by means of movable constituents. More specifically, the gripper 1′ comprises a first gripping element 3 and a second gripping element 4. Both gripping elements 3, 4 are manufactured of sheet metal and curved and angled.

The first gripping element 3 comprises two first lateral holding arms 3′, each first lateral holding arm 3′ comprising a distal free end and a proximal end, the proximal ends being connected to an upper holding means 3″. The first lateral holding arms 3′ are spaced apart from and arranged parallel to each other. The free ends are at least partially tapered which facilitates positioning around plant receptacles 2.

Similarly, the second gripping element 4 comprises two second lateral holding arms 4′, each second lateral holding arm 4′ comprising a distal free end and a proximal end, the proximal ends being connected to a bottom holding means 4″. The second lateral holding arms 4′ are spaced apart from and arranged parallel to each other. The free ends are at least partially tapered which facilitates positioning around plant receptacles 2.

The gripping elements 3, 4 are widely alike in shape and size. They only differ in a single direction of bending. In other words, their manufacturing is almost entirely identical apart from a single manufacturing step. They are arranged parallel to each other and both are connected to the articulated arm 8 by means of two bolts. The articulated arm 8 is rotatably supporting the gripper 1′.

In FIG. 8, the gripper 1′ according to a second embodiment is illustrated schematically in a side view. Also, a plant 2′ that is arranged in a largely elongated plant receptacle 2 is depicted. A longitudinal axis A of the plant receptacle 2 is arranged parallel to a vertical direction V. The plant receptacle 2 comprises a base element 2″ that is made of polyethylene but it is conceivable to employ other plastics as raw material for the production of the plant receptacle 2 as well. The base element 2″ forms a plant cavity 2′″ at an inward direction of the base element 2″ wherein—along with the plant 2′—a potting compost can be filled. The plant 2′ is protruding at least partly beyond a head section 2″″ of the plant receptacle 2. Furthermore, at each of four sides of the plant receptacle 2 one respective recess is formed to save material and hence weight and costs. Most importantly, recesses enable advantageously the provision of water or a water solution that comprises nutrients to the plant receptacle 2 and the potting compost. Moreover, a circumferential rim 9 is formed at the higher end, with respect to FIG. 8, of the plant receptacle 2. The rim 9 comprises four rim portions 9′, each rim portion 9′ being arranged at one side of the base element 2″. In addition, the rim 9 extends outwardly from all four sides of the base element 2″ and is protruding the base element 2″ laterally. The rim 9 or the rim portions 9′ are arranged by and large perpendicular to the longitudinal axis A.

The gripper 1′ in FIG. 8 is shown in a release position, meaning that the first gripping element 3 and the second gripping element 4 are spaced apart from one another in the vertical direction V, wherein the first gripping element 3 is movably configured and serves as an upper gripping element, whereas the second gripping element 4 is non-movable and acts as a bottom gripping element. The wording release position refers in other words to the circumstance that the rim 9 is not clamped between the two first lateral holding arms 3′ of the first gripping element 3 and the two second lateral holding arms 4′ of the second gripping element 4. A gap is rather formed between the head section 2″″ and the two first lateral holding arms 3′ while the second lateral holding arms 4′ support the rim 9 at two opposing sides of the plant receptacle 2, the second lateral holding arms 4′ each supporting an individual rim portion 9′.

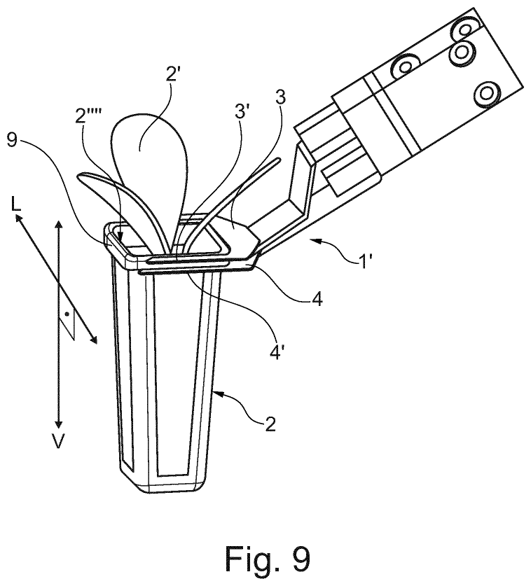

In FIG. 9, the arrangement depicted in FIG. 8 and comprising the gripper 1′ along with the plant receptacle 2 and plant 2′ is illustrated in a perspective view. Furthermore, the entire arrangement is shown in a clamping position. While the second lateral holding arms 4′ supported the two opposing rim portions 9′ from below, the first lateral holding arms 3′ moved downwards in the vertical direction V and in so doing clamped the rim 9. In FIG. 9, the respective displacement of the holding arms 3′ and 4′ in a lateral direction L is obvious, the lateral direction L being perpendicular to the vertical direction V.

In such a clamped position the plant receptacle 2 in conjunction with the plant 2′ can be transported by the actuator 1 to a targeted position within the range of motion of the actuator 1, particularly to the planting walls 20′.

1. An actuator for handling plants and/or plant receptacles in a vertical farming facility, wherein the actuator comprises a robot head for inserting the plants and/or the plant receptacles into apertures of a planting wall of the vertical farming facility, wherein the actuator further comprises an applicator, that is configured to open the apertures prior to inserting the plants and/or plant receptacles by the robot head.

2. The actuator according to claim 1, wherein the applicator is rotatably connected to the actuator, wherein the applicator is rotatable about a pivot axis.

3. The actuator according to claim 1, wherein the applicator comprises a connecting means and a wedge-shaped opening means, the opening means extending at least partially along an outer circumference of the applicator and being formed concentrically or eccentrically around a pivot axis.

4. The actuator according to claim 3, wherein the opening means comprises a first wing and a second wing, the first wing and the second wing are at least partially connected to each other.

5. The actuator according to claim 4, wherein the first wing and the second wing are formed as a single piece.

6. The actuator according to claim 3, wherein the applicator comprises a spacer, the spacer having a first end and a second end, the first end being connected to the first wing and the second end being connected to the second wing

7. The actuator according to claim 3, wherein the opening means extends from a tip portion to an end portion, wherein the tip portion is, with respect to a direction of the pivot axis, narrower than the end portion.

8. The actuator according to claim 7, wherein the opening means comprises an external width parallel to the pivot axis, the external width increasing continuously from the tip portion till the end portion.

9. The actuator according to claim 3, wherein the opening means comprises a groove at its outer circumference which is tapered in a peripheral direction in such a manner that an internal width of the groove parallel to the pivot axis increases in a pivoting direction around the pivot axis from the tip portion till the end portion.

10. The actuator according to claim 1, wherein the robot head comprises a gripper.

11. The actuator according to claim 7, wherein the actuator is configured in such a manner that the tip portion is at least partially inserted into an aperture of the planting wall in a first step and that the applicator is rotated about the pivot axis in pivoting direction to enlarge an opening cross-section of the aperture in a second step.

12. The actuator according to claim 11, wherein the actuator is configured in such a manner that the plants and/or plant receptacles are inserted into the opened aperture by the gripper in a third step.

13. A vertical farming facility comprising the planting wall and the actuator according to claim 1.

14. The vertical farming facility according to claim 13, wherein:
the vertical farming facility comprises a cantilever and a beam, the beam being movably connected to the cantilever and the actuator being movably connected to the beam,
the cantilever is arranged mainly horizontally and comprises a cantilever axis and the beam is arranged mainly vertically and comprises a beam axis, and
the cantilever is movable within the vertical farming facility.

15. The vertical farming facility according to claim 14, wherein the cantilever comprises a first free end section and a first connecting end section and/or the beam comprises a second free end section and a second connecting end section, wherein the cantilever is:
arranged beneath and perpendicular to the planting walls, the planting walls being parallel to each other,
connected via the first free end section to a second facility wall and via the first connecting end section to a first facility wall, the first facility wall and the second facility wall being parallel to each other,
movable translationally in a direction parallel to the facility walls.

16. A method for inserting the plants and/or the plant receptacles into the planting wall in the vertical farming facility with an the applicator according to claim 1, wherein the applicator is at least partially inserted into the aperture of the planting wall in a first step, the applicator is rotated about a pivot axis in a pivoting direction to enlarge an opening cross-section of the aperture in a second step and the plants and/or plant receptacles is inserted into the opened.
